(19) United States
(12) Patent Application Publication
(10) Pub. No.: US 2026/0250993 A1
(43) Pub. Date: Aug. 27, 2026

(54) LOCKING MECHANISM FOR A RACK MOUNTABLE TO A ROOF OF A VEHICLE AND RACK MOUNTABLE TO A ROOF OF A VEHICLE COMPRISING SAME

(71) Applicant: 9358-3433 QUEBEC INC., Quebec (CA)

(72) Inventors: Alexandre BELANGER DESBIENS, Quebec (CA); Vincent THIBAULT, Quebec (CA); Baptiste MAUSSET, Quebec (CA); Mario LEPIRE, Quebec (CA); Morgane LE NOURY, Quebec (CA)

(21) Appl. No.: 18/861,558

(22) PCT Filed: Apr. 28, 2023
(86) PCT No.: PCT/CA2023/050581

§ 371 Date: Oct. 29, 2024

Related U.S. Application Data
(60) Provisional application No. 63/363,886, filed on Apr. 29, 2022.

(51) Int. Cl. E05B 83/00; B60R 9/042

(52) U.S. Cl. CPC E05B 83/00; B60R 9/042

(57) ABSTRACT

A locking mechanism for a rack comprising: a locking tab; a rotating locking pin; a locking tooth; a rotation biasing member and an angular rotation restriction assembly. The locking pin extends along a longitudinal axis and is rotatable thereabout. It is longitudinally movable along the longitudinal axis as the rack is moved into the transport configuration or away therefrom. It includes the locking tooth at a distal end thereof and is rotatable between a locking angular orientation and an unlocked angular orientation. The rotation biasing member torsionally biases the rotating locking pin into the locking angular orientation. The angular rotation restriction assembly is activatable when the rotating locking pin is rotated into the unlocked angular orientation and the rack is configured in the transport configuration and is configured to temporarily maintain the rotating locking pin in the unlocked angular orientation.

### TECHNICAL FIELD OF THE INVENTION

The present invention relates to the field of racks for a roof of a vehicle. More particularly, it relates to a locking mechanism for a rack mountable on a roof of a vehicle and to a rack mountable on a roof of a vehicle comprising the same.

### BACKGROUND

Many types and models of racks mountable to a roof of a vehicle are known in the art. Usually, the racks require users to lift articles, such as bikes, skis, watercrafts, etc., over the roof of the vehicle onto which the rack is installed, in order to load and secure the articles onto the rack. In cases where a storage roof box is mounted to roof bars mounted on the roof of a vehicle, users are also required to lift the articles over the roof of the vehicle and the roof box mounted thereon, to insert the articles into the roof box.

In some cases, racks are designed to allow pivoting of at least a portion thereof towards the ground, in order to momentarily lower the corresponding portion of the rack and therefore facilitate the loading and securement of an article onto the rack, by a user standing on the ground, or insert an article in a roof box mounted thereon. Once the article has been loaded and secured onto the rack (or inserted in the roof box mounted on the rack), the corresponding section of the rack can be pivoted back upwardly for subsequent transport of the article (or roof box) secured to the rack and positioned over the roof of the vehicle. Such racks are especially useful for securing large articles such as watercrafts (e.g. kayaks, canoes, roof boxes, etc.) or the like onto the rack for transport thereof.

Racks which are mountable to the roof of a vehicle and have pivoting sections commonly require to be locked in place, when positioned in a transport configuration where the corresponding section of the rack is positioned above the roof of the vehicle and where the vehicle is used (either with the rack empty or carrying an article secured to the rack).

Known locking mechanism for such racks which are mountable to the roof of a vehicle and have pivoting sections, which allow the locking the rack in place, when positioned in the transport configuration are known for temporarily maintaining the rack in its transport configuration are also known. However, known locking mechanism tend to suffer from several drawbacks hindering the ease of use of the rack, manoeuvrability of the rack and/or user enjoyment of the rack, especially when being operated by a single user.

In view of the above, there is a need for an improved locking mechanism for a rack mountable on a roof of a vehicle and to a rack mountable on a roof of a vehicle comprising the same which, by virtue of its design and components, would be able to overcome or at least minimize some of the above-discussed prior art concerns.

### SUMMARY OF THE INVENTION

In accordance with a first general aspect, there is provided a locking mechanism for a rack mountable to a roof rack of a vehicle and movable to a transport configuration. The locking mechanism comprises: a locking tab; a rotating locking pin extending along a longitudinal axis and rotatable about the longitudinal axis, the rotating locking pin being longitudinally movable along the longitudinal axis as the rack is moved to the transport configuration or is moved away from the transport configuration; a locking tooth positioned at a distal end of the rotating locking pin, with the rotating locking pin being rotatable between a locking angular orientation where the locking tooth is engageable with the locking tab as the locking pin is moved longitudinally along the longitudinal axis and an unlocked angular orientation where the locking tooth does not engage with the locking tab as the locking pin is moved longitudinally along the longitudinal axis; a rotation biasing member rotatively biasing the rotating locking pin towards the locking angular orientation; and an angular rotation restriction assembly activatable when the rotating locking pin is rotated into the unlocked angular orientation and the rack is configured in the transport configuration, the angular rotation restriction assembly being configured to maintain the rotating locking pin in the unlocked angular orientation until the angular rotation restriction assembly is deactivated.

In an embodiment, the angular rotation restriction assembly is configured to be automatically deactivated when the rack is moved away from the transport configuration.

In an embodiment, the angular rotation restriction assembly comprises: a pin engagement member having a pin engagement section biased towards a section of the peripheral surface of the rotating locking pin when the rack is configured in the transport configuration and unbiased when the rack is moved away from the transport configuration; and a stopper defined in the peripheral surface of the rotating locking pin, the stopper being sized and positioned to abut against at least a portion of the pin engagement section of the pin engagement member when the rotating locking pin is rotated into the unlocked angular orientation and thereby prevent rotation of the rotating locking towards the locking angular orientation while the pin engagement section is biased towards the section of the peripheral surface of the rotating locking pin.

In an embodiment, the pin engagement member includes the pin engagement section and a rack engagement section, the pin engagement member being made of resilient material with the pin engagement section and rack engagement section being spaced apart from one another, and wherein the rack engagement section is abutted against a fixed surface of the rack when the rack is positioned in the transport configuration, to compress the rack engagement section towards the pin engagement section and bias the pin engagement section towards the peripheral surface of the rotating locking pin, and the rack engagement section is disengaged from the fixed surface of the rack when the rack is moved away from the transport configuration.

In an embodiment, each one of the locking tooth and the locking tab includes an abutment surface and a locking surface, at least one of the abutment surface of the locking tooth and the locking tab being bevelled to cause a momentary rotation of the rotating locking pin as the locking tooth is moved past the locking tab by a forward longitudinal movement of the locking pin and the abutment surface of the locking tooth and the locking tab are abutted against one another, when the rack is moved to the transport configuration, with the rotation biasing member rotating the locking pin in the locking angular orientation once the locking tooth moves past the locking tab, thereby preventing a rearward longitudinal movement of the locking pin as the locking surface of the locking tooth is engageable to the locking surface of the locking tab.

In an embodiment, the locking mechanism further comprises a handle mounted to the rotating locking pin at a proximal end thereof, the handle being rotationally fixed with the rotating locking pin such that rotation of the handle causes rotation of the rotating locking pin.

In an embodiment, the handle includes a cam shaped section and is pivotable relative to the rotating locking pin about a handle pivot point between a release configuration and a tightened configuration, with the movement of the cam shaped section thereof against a handle abutment surface causing a longitudinal retraction of the locking pin along the longitudinal axis, towards the handle and away from the locking tab, when the handle is pivoted from the release configuration to the tightened configuration.

In an embodiment, the locking mechanism further comprises a longitudinal biasing spring biasing the rotating locking pin towards the locking tab and away from the handle.

In an embodiment, the locking mechanism further comprises a spring-loaded block including a spring longitudinally compressible along the X axis, the spring-loaded block being presurable against a fixed section of the rack when the handle is moved to the tightened configuration.

In accordance with another general aspect, there is provided a rack mountable to a roof rack of a vehicle and movable to a transport configuration where the rack extends over the roof of the vehicle. The rack comprises: at least one elongated base section mountable to the roof rack of the vehicle; at least one pivoting link associated to a corresponding elongated base section of the at least one elongated base section and being rotatably mounted thereto; an article support including at least one bracket associated to a corresponding one of the at least one pivoting link, each one of the at least one bracket having an upper end pivotally connected to the corresponding pivoting link; and a locking mechanism. The locking mechanism comprises: a locking tab; a rotating locking pin extending along a longitudinal axis and rotatable about the longitudinal axis, the rotating locking pin being longitudinally movable along the longitudinal axis as the rack is moved to the transport configuration or is moved away from the transport configuration, a locking tooth positioned at a distal end of the rotating locking pin, with the rotating locking pin being rotatable between a locking angular orientation where the locking tooth is engageable with the locking tab as the locking pin is moved longitudinally along the longitudinal axis and an unlocked angular orientation where the locking tooth does not engage with the locking tab as the locking pin is moved longitudinally along the longitudinal axis; a rotation biasing member rotatively biasing the rotating locking pin towards the locking angular orientation; and an angular rotation restriction assembly activatable when the rotating locking pin is rotated into the unlocked angular orientation and the rack is configured in the transport configuration, the angular rotation restriction assembly being configured to maintain the rotating locking pin in the unlocked angular orientation until the angular rotation restriction assembly is deactivated.

In an embodiment, the locking mechanism comprises at least one locking unit associated with a bracket of the article support and the corresponding elongated base section associated to the pivoting link associated with the bracket, the locking unit including a mobile portion mounted to the bracket and a fixed portion mounted to the elongated base section, the mobile portion being engageable with the fixed portion when the rack is configured in the transport configuration and wherein the locking tab is part of the fixed portion of the locking unit, while the rotation locking pin, locking tooth, rotation biasing member and angular rotation restriction assembly are part of the fixed portion of the locking unit.

In an embodiment, the fixed portion of the locking unit includes a projecting lip engageable under a section of the fixed portion of the locking unit, when the mobile portion is engaged with the fixed portion.

In an embodiment, the angular rotation restriction assembly of the locking mechanism is configured to be automatically deactivated when the rack is moved away from the transport configuration.

In an embodiment, the angular rotation restriction assembly of the locking mechanism comprises: a pin engagement member having a pin engagement section and a rack engagement section, with the pin engagement section being biased towards a section of the peripheral surface of the rotating locking pin when the rack is configured in the transport configuration and unbiased when the rack is moved away from the transport configuration; and a stopper defined in the peripheral surface of the rotating locking pin, the stopper being sized and positioned to abut against at least a portion of the pin engagement section of the pin engagement member when the rotating locking pin is rotated into the unlocked angular orientation and thereby prevent rotation of the rotating locking towards the locking angular orientation while the pin engagement section is biased towards the section of the peripheral surface of the rotating locking pin.

In an embodiment, the pin engagement member is made of resilient material with the pin engagement section and rack engagement section being spaced apart from one another, and wherein the rack engagement section is abutted against an engagement surface of the corresponding elongated base section when the rack is positioned in the transport configuration, to compress the rack engagement section towards the pin engagement section and bias the pin engagement section towards the peripheral surface of the rotating locking pin, and the rack engagement section is disengaged from the engagement surface of the corresponding elongated base section.

In an embodiment, each one of the locking tooth and the locking tab assembly of the locking mechanism includes an abutment surface and a locking surface, at least one of the abutment surface of the locking tooth and the locking tab being bevelled to cause a momentary rotation of the rotating locking pin as the locking tooth is moved past the locking tab by a forward longitudinal movement of the locking pin and the abutment surface of the locking tooth and the locking tab are abutted against one another, when the rack is moved to the transport configuration, with the rotation biasing member rotating the locking pin in the locking angular orientation once the locking tooth moves past the locking tab, thereby preventing a rearward longitudinal movement of the locking pin as the locking surface of the locking tooth is engageable to the locking surface of the locking tab.

In an embodiment, the locking mechanism further comprises a handle mounted to the rotating locking pin at a proximal end thereof, the handle being rotationally fixed with the rotating locking pin such that rotation of the handle causes rotation of the rotating locking pin.

In an embodiment, the handle includes a cam shaped section and is pivotable relative to the rotating locking pin about a handle pivot point between a release configuration and a tightened configuration, with the movement of the cam shaped section thereof against a handle abutment surface causing a longitudinal retraction of the locking pin along the longitudinal axis, towards the handle and away from the locking tab, when the handle is pivoted from the release configuration to the tightened configuration.

In an embodiment, the locking mechanism further comprises a longitudinal biasing spring biasing the rotating locking pin towards the locking tab and away from the handle.

In an embodiment, the locking mechanism further comprises a spring-loaded block including a spring longitudinally compressible along the X axis, the spring-loaded block being presurable against a section of the elongated base section of the rack when the handle is moved to the tightened configuration.

### BRIEF DESCRIPTION OF THE DRAWINGS

Other objects, advantages and features will become more apparent upon reading the following non-restrictive description of embodiments thereof, given for the purpose of exemplification only, with reference to the accompanying drawings in which:

FIG. 1 is an isometric view of the rack shown mounted on a roof rack of a vehicle and in a transport configuration, in accordance with an embodiment.

FIG. 2 is an isometric view of the rack of FIG. 1, shown mounted on a roof rack of a vehicle and in a loading configuration.

FIG. 3 is an enlarged isometric view of the rack of FIGS. 1 and 2 showing the locking mechanism in accordance with a first embodiment with a cover covering the components thereof.

FIGS. 3A to 3F are cross-sectional isometric views taken along lines 3A-3F shown in FIG. 3, and showing the locking mechanism in accordance with the first embodiment in different operating configurations, wherein:

FIG. 3A shows the locking mechanism of the first embodiment in a disengaged configuration;

FIG. 3B shows the locking mechanism of the first embodiment in a first engagement configuration;

FIG. 3C shows the locking mechanism of the first embodiment in a second engagement configuration;

FIG. 3D shows the locking mechanism of the first embodiment in a locked configuration;

FIG. 3E shows the locking mechanism of the first embodiment in a locked and tightened configuration; and

FIG. 3F shows the locking mechanism of the first embodiment in an unlocked configuration.

FIGS. 4A and 4B are close up cross-sectional views of the pin and pin engagement member of an angular rotation restriction assembly of the locking mechanism of the first embodiment, with the locking mechanism in different operating configurations, wherein:

FIG. 4A shows the pin and pin engagement member when the locking mechanism is in the locked configuration of FIG. 3D; and

FIG. 4B shows the pin and pin engagement member when the locking mechanism is in the unlocked configuration of FIG. 3F.

FIG. 5 is again an enlarged isometric view of the rack of FIGS. 1 and 2 showing the locking mechanism in accordance with a second embodiment with a cover covering the components thereof.

FIGS. 5A to 5F are cross-sectional isometric views taken along lines 5A-5F shown in FIG. 5, and showing the locking mechanism in accordance with the second embodiment in different operating configurations, wherein:

FIG. 5A shows the locking mechanism of the second embodiment in a disengaged configuration;

FIG. 5B shows the locking mechanism of the second embodiment in a first engagement configuration;

FIG. 5C shows the locking mechanism of the second embodiment in a second engagement configuration;

FIG. 5D shows the locking mechanism of the second embodiment in a locked configuration;

FIG. 5E shows the locking mechanism of the second embodiment in a locked and tightened configuration; and

FIG. 5F shows the locking mechanism of the second embodiment in an unlocked configuration.

FIGS. 6A and 6B are close up cross-sectional views of the pin and pin engagement member of the angular rotation restriction assembly of the locking mechanism of the second embodiment with the locking mechanism in different operating configurations, wherein:

FIG. 6A shows the pin and pin engagement member when the locking mechanism is in the locked configuration of FIG. 5D; and

FIG. 6B shows the pin and pin engagement member when the locking mechanism is in the unlocked configuration of FIG. 5F.

### DETAILED DESCRIPTION

In the following description, the same numerical references refer to similar elements. The embodiments, geometrical configurations, materials mentioned and/or dimensions shown in the figures or described in the present description are embodiments only, given solely for exemplification purposes.

Moreover, although the embodiments of the locking mechanism for a rack mountable on a roof of a vehicle and the rack mountable on the roof of the vehicle comprising the locking mechanism, and corresponding parts thereof, consist of certain geometrical configurations as explained and illustrated herein, not all of these components and geometries are essential and thus should not be taken in their restrictive sense. It is to be understood, as also apparent to a person skilled in the art, that other suitable components and cooperation thereinbetween, as well as other suitable geometrical configurations, may be used for the locking mechanism for a rack mountable on a roof of a vehicle and the rack mountable on the roof of the vehicle comprising the locking mechanism, as will be briefly explained herein and as can be easily inferred herefrom by a person skilled in the art. Moreover, it will be appreciated that positional descriptions such as “above”, “below”, “up”, “down”, “left”, “right” and the like should, unless otherwise indicated, be taken in the context of the figures and should not be considered limiting.

To provide a more concise description, some of the quantitative and qualitative expressions given herein may be qualified with the terms “about” and “substantially”. It is understood that whether the terms “about” and “substantially” are used explicitly or not, every quantity or qualification given herein is meant to refer to an actual given value or qualification, and it is also meant to refer to the approximation to such given value or qualification that would reasonably be inferred based on the ordinary skill in the art, including approximations due to the experimental and/or measurement conditions for such given value.

The terms “a”, “an” and “one” are defined herein to mean “at least one”, that is, these terms do not exclude a plural number of items, unless stated otherwise.

Unless stated otherwise, the terms “connected” and “coupled”, and derivatives and variants thereof, refer herein to any structural or functional connection or coupling, either direct or indirect, between two or more elements. For example, the connection or coupling between the elements can be acoustical, mechanical, optical, electrical, thermal, logical, or any combinations thereof.

The terms “match”, “matching” and “matched” are intended to refer herein to a condition in which two elements are either the same or within some predetermined tolerance of each other. That is, these terms are meant to encompass not only “exactly” or “identically” matching the two elements but also “substantially”, “approximately” or “subjectively” matching the two elements, as well as providing a higher or best match among a plurality of matching possibilities.

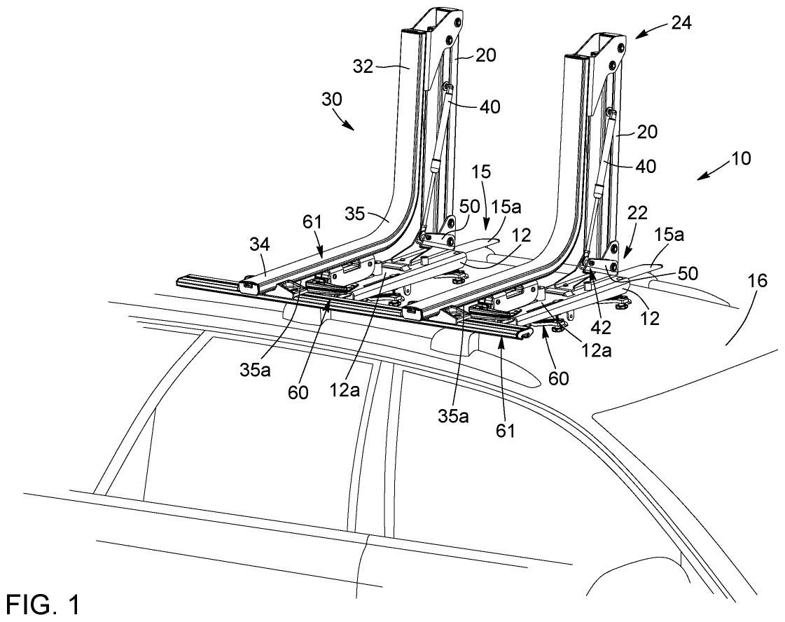

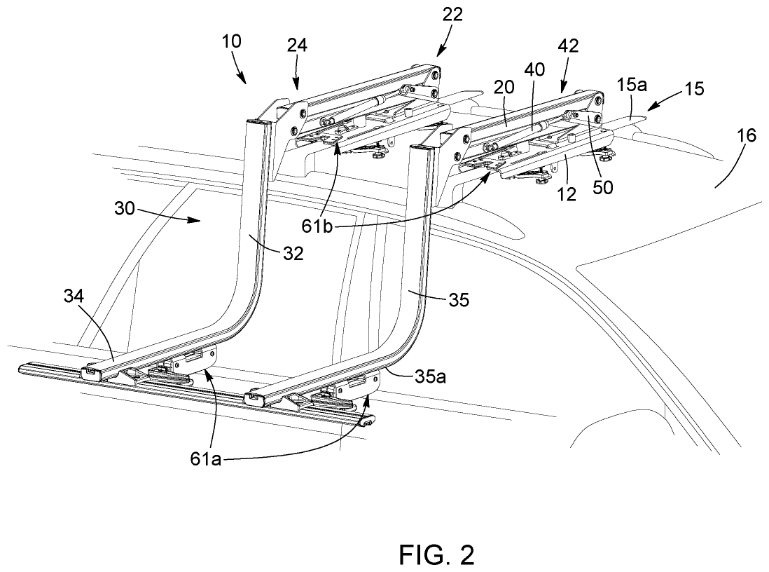

In general terms, and referring generally to FIGS. 1 and 2, there is provided a rack 10 pivotable between a transport configuration (see FIG. 1) and a loading configuration (see FIG. 2). As can be seen from the Figures, the design and operation of the rack 10 allows a transition from the transport configuration (shown in FIG. 1), where the rack 10 is configured in a compacted arrangement and is positioned substantially entirely over a vehicle 16, to the loading configuration (shown in FIG. 2), where the rack 10 is configured in a deployed arrangement, with an article support 30 of the rack 10 being extended in a cantilever position and lowered towards the ground on a side of the vehicle 16.

The rack 10 is intended to be mounted on a roof rack 15 of the vehicle 16. In order to do so, the rack 10 includes elongated base sections 12 (operating as fixed base) securable to the roof bars 15a of a roof rack 15 of a corresponding vehicle 16. The base sections 12 have an engagement surface 12a. In the course of the present document, the term “engagement surface” is used to refer either directly to an upper surface of the base sections 12 or to any adjacent surfaces onto which a component can abut to engage the base section 12, such as, for example and without being limitative, a surface of a bracket, anchor or the like mounted on the base sections, a surface of an abutment stopper extending from the upper surface of the base sections, etc.

In the embodiment shown, two elongated base sections 12 spaced apart from one another and positioned to be mounted to corresponding roof bars 15 extending transversally on a roof of a vehicle 16 are provided. One skilled in the art will understand that, in alternative embodiments (not shown), more or less than the two elongated base sections 12 could be provided. Moreover, the base sections 12 (or fixed base) could be embodied using different component(s) or component(s) having a different configuration, to secure the rack 10 to the roof of the vehicle 16 directly or indirectly (e.g. with or without the use of roof bars 15).

In the embodiment shown, the rack 10 also includes pivoting links 20 (or bars), an article support 30 operatively connected to the pivoting links 20, and lift-assisting struts (or shock absorber) 40 cooperating with the pivoting links 20 to capture and control the load when a loaded rack 10 (i.e. the rack 10 with an article secured thereto) is pivoted between the transport configuration (see FIG. 1) and the loading configuration (see FIG. 2), and assist in the inverse movement of the rack 10 (i.e. assist the movement of the rack 10 during a portion of the movement between the loading configuration (see FIG. 2) and the transport configuration (see FIG. 1).

Each pivoting link 20 is associated to a corresponding elongated base section 12 and has a proximal end 22 and a distal end 24. The proximal end 22 is the end positioned proximate to the corresponding elongated base section 12, while the distal end 24 is the opposed end positioned the farthest from the corresponding elongated base section 12, when the rack 10 is configured in the transport configuration (as shown in FIG. 1). Each pivoting link 20 is pivotally mounted relative to the corresponding elongated base sections 12 at the proximal end 22 thereof.

The article support 30 is the portion of the rack 10 designed for loading the articles on the rack 10 (i.e. the portion of the rack for receiving the articles thereon). In the embodiment shown, the article support 30 is “L” shaped and includes two matching L shaped bracket 35 laterally spaced apart from one another and each having a substantially vertical section 32 and a substantially horizontal section 34. The substantially vertical section 32 of each bracket 35 has an upper end 33 pivotally connected to the distal end 24 of the pivoting links 20.

In the embodiment shown, the substantially horizontal sections 34 are connected by a handle 36 section extending therebetween, to connect the brackets 35 and provide rigidity to the rack 10.

In the embodiment shown, in the loading configuration (See FIG. 2), the article support 30 of the rack 10 is lowered and extends laterally from the roof vehicle 16 onto which the rack 10 is mounted, with a substantially vertical section 32 of the article support 30 being substantially parallel to a corresponding side panel of the vehicle 16 and a substantially horizontal sections 34 of the article support 30 being substantially perpendicular to the corresponding side panel of the vehicle 16. In an embodiment, the rack 10 is designed such that the substantially horizontal sections 34 of the article support 30 remain substantially horizontal throughout the pivoting of the rack 10 between the transport configuration (See FIG. 1) and the loading configuration (see FIG. 2) and vice-versa.

In order to assist in the transition of the rack 10 between the transport configuration and the loading configuration (and vice-versa), the rack 10 further includes the lift-assisting struts (or shock absorber) 40. In the embodiment shown, two lift-assisting struts 40 are provided, each lift-assisting strut 40 cooperating with corresponding pivoting links 20. One skilled in the art will however understand that, in an alternative embodiment (not shown), a different amount and or type of lift-assisting struts 40 could be provided. When the rack 10 is loaded with an article (especially a heavy article such as a watercraft or the like), the lift-assisting strut 40 helps controlling the movement of the article support 30 of the rack 10 during a portion of the movement, thereby preventing the article support 30 from being lowered too rapidly towards the ground and/or facilitating the upward movement of the article support 30 during a portion of the movement towards the transport configuration.

In the embodiment shown, each lift-assisting strut 40 is a piston, such as, for example and without being limitative, a gas piston, a hydraulic piston, a spring-loaded piston or the like. One skilled in the art will however understand that, in an alternative embodiment, other linear shock absorbers could be used.

In order to allow a substantially resistance free angular range of motion to the rack 10, during a predetermined pivoting segment performed adjacent to the transport configuration, in an embodiment, a proximal end 42 of each lift-assisting strut 40 is pivotally connected to a pivoting arm (or link) 50, pivotable relative to the corresponding elongated base section 12, therefore allowing the proximal end 42 of each lift-assisting strut 40 to move angularly relative to the corresponding elongated base section 12, without resistance from the corresponding lift-assisting strut 40, for a predetermined angular distance. The pivoting arm (or link) 50 and the functioning thereof is described in detail in international PCT patent application no. PCT/CA2019/050760 filed May 31, 2019, the content of which being included herein by reference.

As will be described in more details below, the rack 10 also includes a locking mechanism 60 configured to automatically lock the rack 10 in place, when the rack is brought in the transport configuration and thereby prevent undesired movement of the components of the rack 10 away from the transport configuration, while allowing easy unlocking by a single user, even on big and/or high roof vehicles.

In the embodiment shown, the locking mechanism 60 includes two locking units 61 with each one of the locking units 61 being associated with a corresponding bracket 35 of the article support 30 and base section 12. The two locking units 61 are similar and operate similarly.

One skilled in the art will understand that, in alternative embodiments (not shown), the locking mechanism 60 could include a single locking unit 61 or more than two locking units 61 and/or the one or more locking unit 61 can be mounted on the rack in connection with components different than the bracket 35 of the article support 30 and the base section 12. For example and without being limitative, in an embodiment (not shown), a single locking unit 61 could be provided in connection with a corresponding one of two or more brackets 35 of the article support 30 and base sections 12. For example and without being limitative, in another alternative embodiment (not shown) where the article support 30 comprises a single bracket 35, a single locking unit 61 could be provided in connection with the single bracket 35 of the article support 30 and a corresponding base section 12. In yet another alternative embodiment (not shown) where the article support 30 includes more than two brackets 35, a number of locking units 61 corresponding with the number of brackets 35 could be provided, with a locking unit 61 being provided for each bracket 35 of the article support 30 and associated base section 12.

In the description below, for ease of description, a single locking unit 61 will be described. One skilled in the art would however understand that the description could apply to any additional locking unit 61 of the locking mechanism 60.

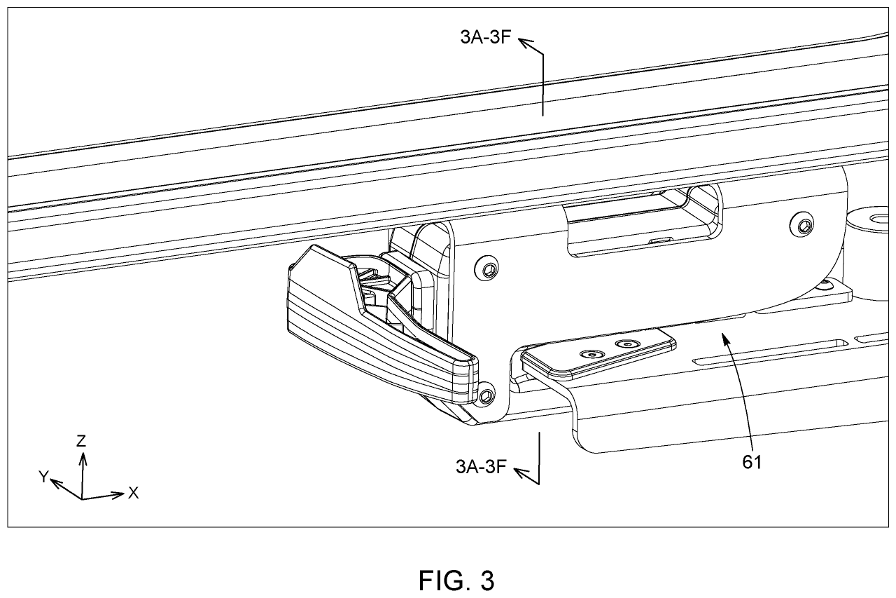

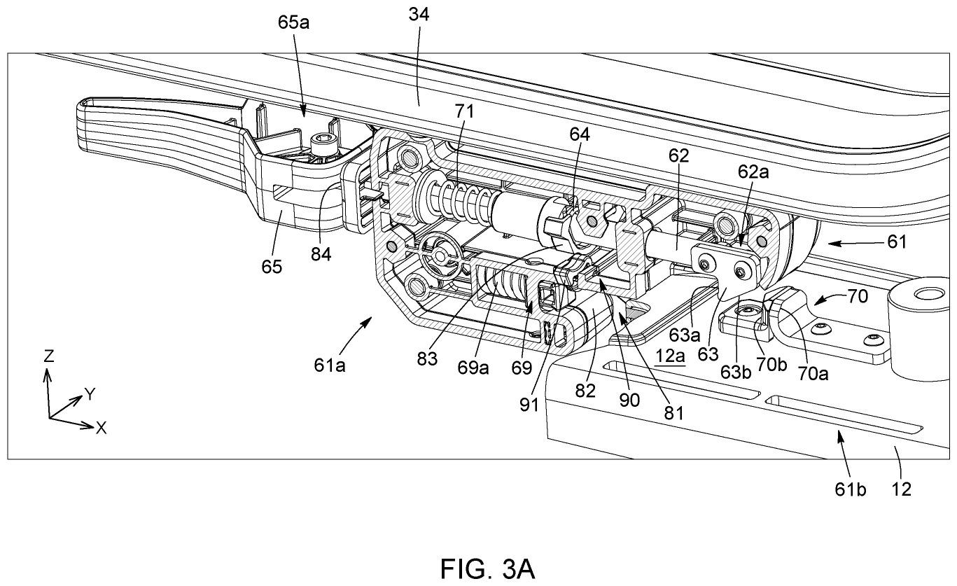

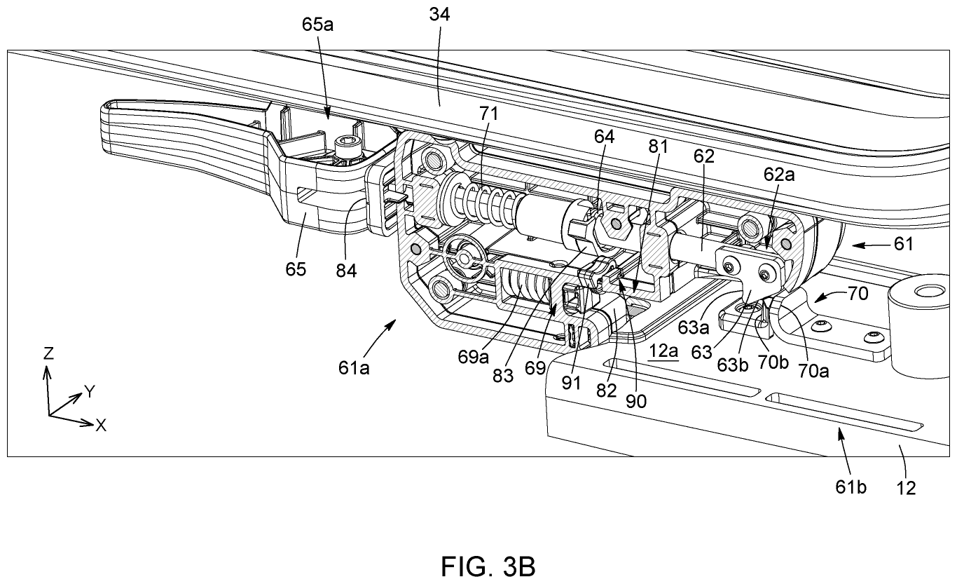

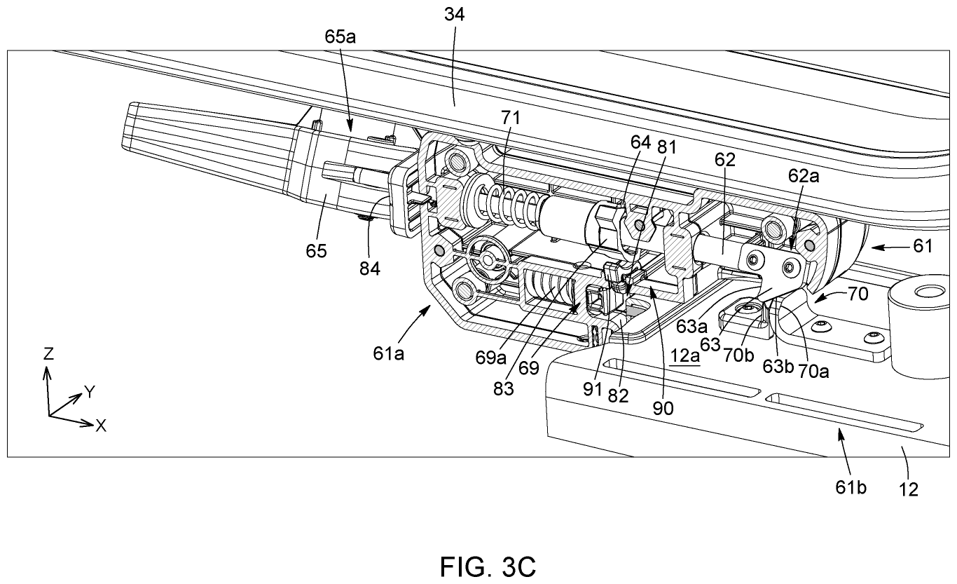

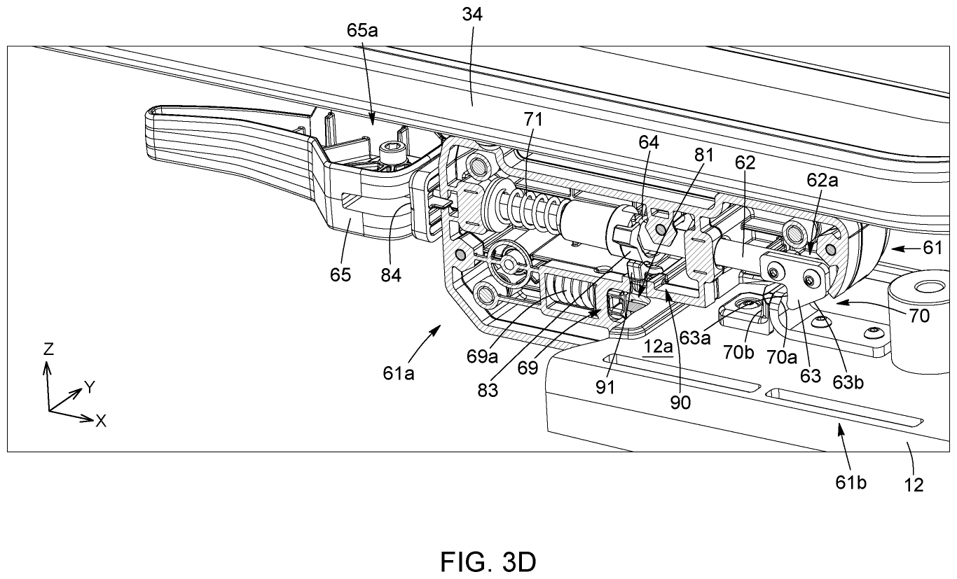

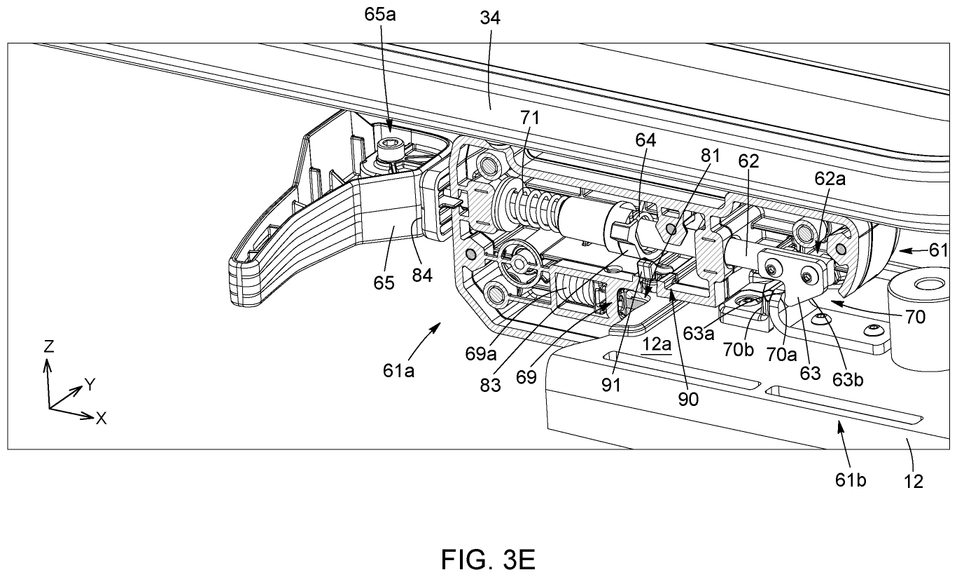

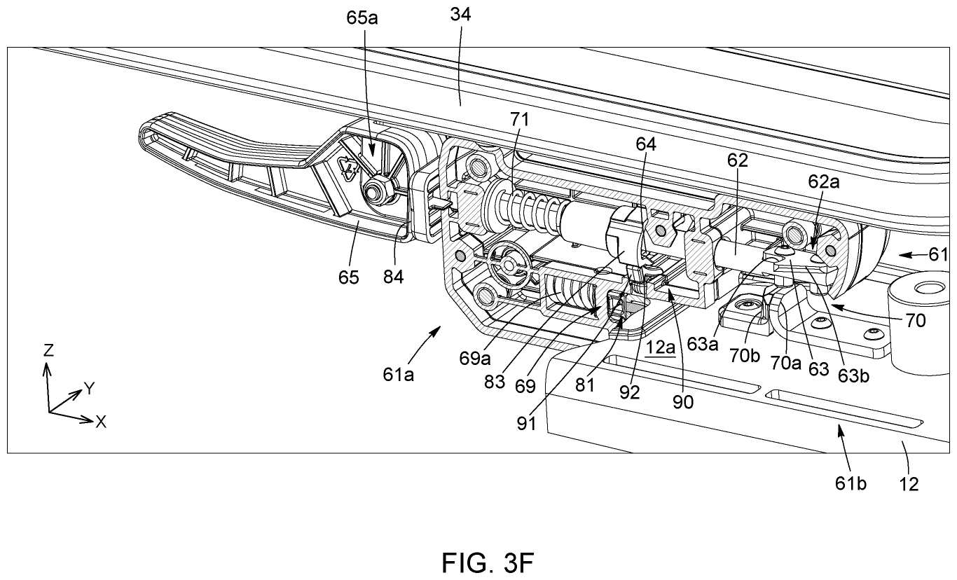

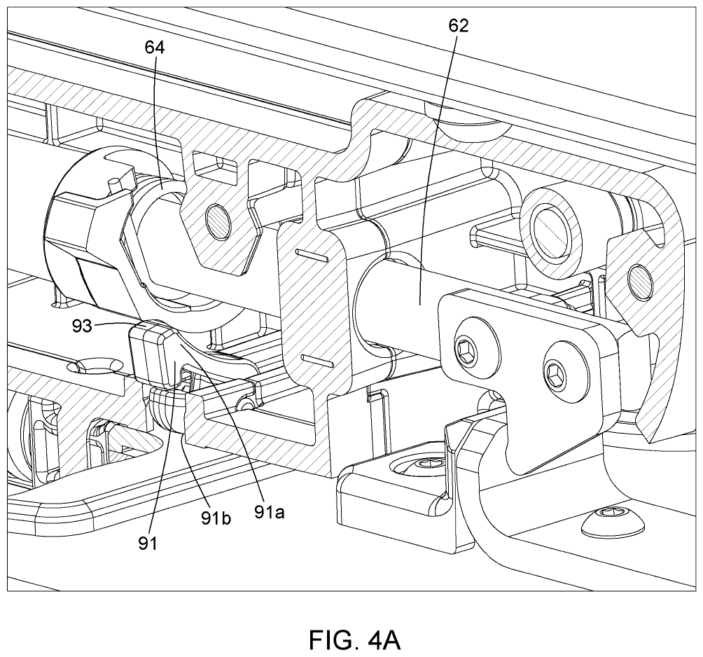

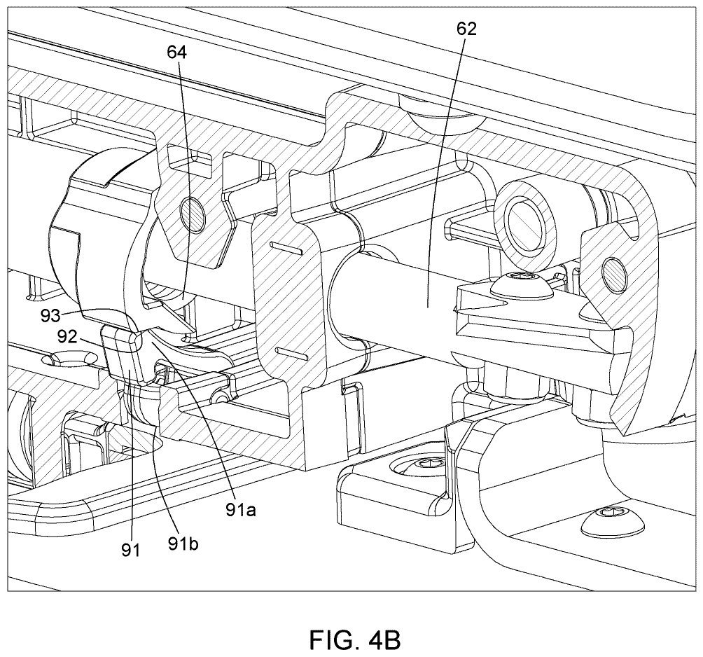

Referring generally to FIGS. 3 to 4B, in accordance with one embodiment, there is provided a first embodiment of the locking mechanism 60. The locking unit 61 of the locking mechanism 60 includes a mobile portion 61a and a fixed portion 61b engageable with one another. In the embodiment shown, the mobile portion 61a is mounted on a lower surface 35a of the substantially horizontal section 34 of the corresponding bracket 35 of the article support 30 and the fixed portion 61b is positioned on the corresponding base section 12 of the rack 10. The mobile portion 61a of the locking unit 61 therefore moves along with the movement of the article support 30, when the article support 30 is displaced between the transport configuration and the loading configuration, and vice-versa. One skilled in the art will understand that in alternative embodiments (not shown), the mobile portion 61a and fixed portion 61b could be mounted to different components of the rack 10 than the lower surface 35a of the substantially horizontal section 34 of the corresponding bracket 35 of the article support 30 and the corresponding base section 12 as shown in this embodiment. Moreover, even though the description below presents the components of the locking unit 61 as being part of one of the mobile portion 61a or fixed portion 61b of the locking unit 61, one skilled in the art will understand that, in alternative embodiments (not shown), the components of the locking unit 61 could be distributed differently (i.e. could be part of another one of the mobile portion 61a or the fixed portion 61b of the locking unit 61 than shown in the figure and described hereinbelow).

In the embodiment shown, the fixed portion 61b of the locking unit 61 includes a recessed receiving inlet 81 defined therein, for receiving a section of the mobile portion 61a of the locking unit 61, when the mobile portion 61a of the locking unit 61 is engaged with the fixed portion 61b of the locking unit 61. The recessed receiving inlet 81 helps to ensure alignment of the components of the mobile portion 61a and the fixed portion 61b, when the mobile portion 61a of the locking unit 61 is engaged with the fixed portion 61b of the locking unit 61. Moreover, in the embodiment shown, the mobile portion 61a of the locking unit 61 includes a projecting lip 82 engageable under a section of the fixed portion 61b of the locking unit 61, when the mobile portion 61a of the locking unit 61 is engaged with the fixed portion 61b, thereby preventing the mobile portion 61a of the locking unit 61 to be moved upwardly away from the fixed portion 61b of the locking unit 61, while the mobile portion 61b of the locking unit 61 is engaged with the fixed portion 61b.

The fixed portion 61b of the locking unit 61 also includes a locking tab 70. In the embodiment shown, the locking tab 70 projects upwardly from the engagement surface 12a of the corresponding base section 12. One skilled in the art will however understand that, in alternative embodiments (not shown) the locking tab 70 (and other components of the fixed portion 61b of the locking unit 61) could be mounted to or positioned along a different component of the rack 10 which allow the components to be fixedly mounted to the rack and be engageable by the components of the mobile portion 61a of the locking unit 61, when the rack 10 is brought in the transport configuration. The locking tab 70 (and other components of the fixed portion 61b of the locking unit 61) could also be oriented differently that in the embodiment shown, with the positioning and orientation of the components of the mobile portion 61a being adapted accordingly.

The locking tab 70 includes a locking surface 70a extending substantially perpendicularly from the engagement surface 12a (which extends along a substantially horizontal plan X-Y) of the corresponding base section 12 and substantially along a vertical plan Y-Z (with the longitudinal axis X extending substantially perpendicular to the axes Y and Z). The locking tab 70 also includes a bevelled abutment surface 70b extending forwardly of the locking surface 70a (i.e. positioned to be engaged first by the components of the mobile portion 61a of the locking unit 61, when the rack is brought in the transport configuration and the mobile portion 61a and fixed portion 61b are engaged to one another). In the embodiment shown, the bevelled abutment surface 70b is substantially vertical and angled relative to the vertical plane X-Z (in other words, the locking tab 70 is of a triangular prism shape projecting of the engagement surface 12a (of the corresponding base section 12 with an apex thereof positioned at a forward end). One skilled in the art will understand that, in alternative embodiments (not shown), the locking tab 70 could have a different configuration with a forward beveled engagement surface 12a and a rearwards locking surface 70a extending substantially along a vertical plan Y-Z.

In the embodiment shown, the mobile portion 61a of the locking unit 61 includes a rotating locking pin 62 extending substantially horizontally along a horizontal axis X and rotatable about the horizontal axis X. The rotating locking pin 62 moves along a substantially vertical X-Z plane upon movement of the article support 30 and the corresponding bracket 35, when the article support 30 is moved between the transport configuration and the loading configuration, and vice-versa (i.e. the rotating locking pin 62 remains longitudinally aligned with the substantially vertical X-Z plane upon movement of the article support 30). As can be seen in the sequence of FIGS. 3A to 3F, the rotating locking pin 62 is longitudinally movable along the longitudinal axis X as the rack 10 is moved close to the transport configuration or is moved away from the transport configuration.

The rotating locking pin 62 has a locking tooth 63 mounted thereon at a distal end 62a of the locking pin 62. In an alternative embodiment (not shown), the locking tooth 63 could also be integral to the rotating locking pin 62 (i.e. the locking pin 62 could be a single piece shaped to define a locking tooth 63 at the distal end 62a thereof). The locking tooth 63 defines a cantilevered abutment shoulder having a locking surface 63a extending substantially perpendicularly with a portion of the peripheral surface of the locking pin 62 and a bevelled abutment surface 63b extending between the tip of the locking surface 63a and the locking pin 62, forwardly of the locking surface 63a (i.e. located at the tip of the locking pin 62, at the furthest extremity of the distal end 62a of the locking pin 62, to engage the engagement surface 70b of the locking tab 70 of the locking unit 61 as the rack 10 is brought in the transport configuration and the mobile portion 61a and fixed portion 61b are engaged to one another).

The rotating locking pin 62 is rotatively biased towards a locking angular orientation (as shown in FIGS. 3A, 3B, 3D and 3E, where the locking tooth 63 extends substantially downwardly from the rotating locking pin 62 and is engageable with the locking tab 70) by a rotation biasing member 64. Hence, unless a greater torsional force than the force of the rotation biasing member 64 is exerted on the rotating locking pin 62 or the rotating locking pin 62 is prevented (e.g. by a user interacting with the locking pin 62 or other components of the locking mechanism 61 maintaining the locking pin in a specific angular orientation such as the angular rotation restriction assembly described below), the rotating locking pin 62 is angularly positioned in the locking angular orientation (as shown in FIGS. 3A, 3B, 3D and 3E). In the embodiment shown, the locking tooth 63 extend substantially downwardly from the rotating locking pin 62 when the rotating locking pin 62 is in the locking angular orientation. As will be understood by one skilled in the art, in alternative embodiments (not shown), the locking tooth 63 could be positioned in a different orientation than the one of the embodiment shown when the rotating locking pin 62 is in the locking angular orientation, with the positioning and/or configuration of the other components of the locking unit 61 (such as the locking tab 70 of the fixed portion 61b of the locking unit 61) being adapted to a different orientation of the locking tooth 63, when the rotating locking pin 62 is in the locking angular orientation.

In the embodiment shown, the rotation biasing member 64 is a rotation biasing spring. One skilled in the art will however understand that, in alternative embodiments (not shown), a rotation biasing member 64 different from the rotation biasing spring of the embodiment shown could be used.

In the embodiment shown the rotation biasing spring is positioned inside an annular ring 83 fixedly mounted to the rotating locking pin 62 to rotate therewith and extending over a section thereof. The rotation biasing spring has a first end thereof engageable with a section of the annular ring 83 and a second end engageable with a fixed component of the mobile portion 61a, which does not rotate along with the rotating locking pin 62, such that rotation of the rotating locking pin 62 loads the spring to perform the rotation biasing function thereof towards the locking angular orientation. One skilled in the art will understand that, in alternative embodiments, the rotation biasing spring (or other type of rotation biasing member 64) could be positioned at a different position with regard to the rotating locking pin 62 to perform the necessary rotative bias.

In the embodiment shown, the rotating locking pin 62 is connected to a handle 65 at a proximal end thereof. The handle 65 is rotatable about the horizontal axis X and is rotatively fixedly mounted to the rotating locking pin 62, to rotate the locking pin 62 about the horizontal axis X upon rotation thereof. The handle 65 is also pivotable relative to the rotating locking pin 62 about a handle pivot point 65ab between a release configuration (shown in FIGS. 3A to 3D) and a tightened configuration (shown in FIG. 3E). The handle includes a cam shaped section abutted against a handle abutment surface 84. Hence, the movement of the cam shaped section of the handle 65 against the handle abutment surface 84 forces a longitudinal movement of the rotating locking pin 62 when the handle 65 is pivoted between the release configuration (shown in FIG. 3A to 3D) and the tightened configuration (shown in FIG. 3E) and vice-versa. More particularly, the handle 65 forces the rotating locking pin 62 to retract longitudinally towards the handle 65, when the handle 65 is pivoted between the release configuration (shown in FIG. 3A to 3D) and the tightened configuration (shown in FIG. 3E), to drive the locking surface of locking tooth 63a towards the locking surface of the locking tab 70a, such that any space therebetween is removed and they engage with one another.

In the embodiment shown, a longitudinal biasing spring 71 is also provided to exert a force biasing the rotating locking pin 62 longitudinally away from the handle 65, in order to always maintain a longitudinal tension in the rotating locking pin 62 and prevent any slack in the mechanism 60.

In order to maintain the tension and prevent any slack in the mechanism 60 when the handle is pivoted to the tightened configuration (shown in FIG. 3E), in the embodiment shown, the mobile portion 61a of the locking unit 61 also includes a spring-loaded block 69 presurable against a fixed section of the rack being a section of the base section 12. The spring-loaded block 69 includes a spring 69a longitudinally compressible along the X axis, when the handle 65 is moved to the tightened configuration. One skilled in the art will understand that, in alternative embodiments, the spring-loaded block 69 could be replaced by other components including a resilient material member being compressed when the handle 65 is moved to the tightened configuration.

Referring again to FIGS. 3 to 4B, the mobile portion 61a also includes an angular rotation restriction assembly 90 activatable when the rotating locking pin 62 is rotated into an unlocked angular orientation and the rack 10 is configured in the transport configuration (See FIGS. 3F and 4B). In the unlocked angular orientation, the locking pin 62 is rotatively configured such that locking tooth 63 extends away from the locking tab 70 and cannot be engaged therewith, thereby allowing longitudinal movement of the rotating locking pin 62, without the locking surface of locking tooth 63a engaging the locking surface of the locking tab 70a and restricting longitudinal of the locking pin 62. Once activated, the angular rotation restriction assembly 90 is configured to maintain the rotating locking pin 62 in the unlocked angular orientation until the angular rotation restriction assembly 90 is deactivated.

In the embodiment shown, the angular rotation restriction assembly 90 is embodied by a combination of a pin engagement member 91 abuttable against the peripheral surface of the rotating locking pin 62 and more particularly the side wall the annular ring 83 and a stopper 92 defined in the peripheral surface of the rotating locking pin and more particularly defined by a notch formed in the arcuate sidewall of the annular ring 83 onto which the pin engagement member 91 is abuttable, as described in more details below.

Indeed, in the embodiment shown, the mobile portion 61a of the locking unit 61 includes the pin engagement member 91 positioned and configured to engage with a section of the peripheral surface of the rotating locking pin 62, and more particularly with the side wall of the annular ring 83 mounted on the rotating locking pin 62, when the rack 10 is configured in the transport configuration (see FIG. 4A). The pin engagement member 91 is positioned and configured to be biased towards the side wall of the annular ring 83 when the rack 10 is configured in the transport configuration and to be unbiased when the rack 10 is moved away from the transport configuration. In the embodiment shown, the pin engagement member 91 includes pin engagement section 91a, an abutment wall 93 being a portion of the pin engagement section 91a defined at an upper end thereof, and a rack engagement section 91b. In an embodiment, the pin engagement member 91 is made of resilient material, with the pin engagement section 91a being spaced apart from the rack engagement section 91b. Hence, a spring effect is created when a force is exerted on at least one of the pin engagement section 91a and rack engagement section 91b to compress the pin engagement section 91a and the rack engagement section 91b towards one another.

As mentioned above and better seen in FIG. 4B, the annular ring 83 has an inwardly extending notch created in a section of the peripheral wall thereof, which defines a stopper 92 in the peripheral wall of the rotating locking pin 62. The stopper 92 is positioned at an angular position along the periphery of the rotating locking pin 62 such that it engages with the portion of the pin engagement section 91a being the abutment wall 93 of the pin engagement member 91 when the rotating locking pin 62 is rotated to be angularly positioned in the unlocked angular orientation.

As will be described in more details below, the stopper 92 and the abutment wall 93 of the pin engagement member 91 are configured such that, when the pin engagement member 91 is biased towards the side wall of the annular ring 83 and the rotating locking pin 62 reaches the unlocked angular orientation, the abutment wall 93 of the pin engagement member 91 abuts against the stopper 92 and prevents the rotating locking pin 62 to move towards the locking configuration. Given that, in that unlocked angular orientation, the locking tooth 63 of the rotating locking pin 62 is positioned to extend away from the locking tab 70 (see FIG. 4B and thereby allows free longitudinal movement of the rotating locking pin 62 generated by the movement of the article support 30 (without the locking surface 63a of the locking tooth 63b engaging the locking surface 70a of the locking tab 70), this allows the locking mechanism to be maintained in a non-active state, such that the user can easily drive the rack 10 away from the transport configuration.

Still referring to FIGS. 3A to 4B, the operation of the locking unit 61 will now be described in connection to the different operational positions shown.

In FIG. 3A, the locking unit 61 is shown in a disengaged configuration (with the mobile portion 61a and fixed portion not being engaged to one another) and the rotating locking pin 62 in the locking angular orientation. This configuration occurs as the rack 10 is not in the transport configuration (i.e. is either moved away from the transport configuration or moved towards the transport configuration but has not reached the transport configuration yet).

In FIG. 3B, the locking unit 61 is shown in a first engagement configuration. This configuration occurs as the rack 10 is moved towards the transport configuration and the mobile portion 61a and fixed portion start engaging one another. As can be seen in FIG. 3B, in this configuration, the abutment surface 63b of the locking tooth 63 of the rotating locking pin 62 initially abuts the engagement surface 70b of the locking tab 70, as the rack 10 is moved to be brought in the transport configuration.

In FIG. 3C the locking unit 61 is shown in a second engagement configuration occurring as the rack 10 is moved further towards the transport configuration. As can be seen in FIG. 3C, the engagement of the bevelled abutment surface 63b of the locking tooth 63 of the rotating locking pin 62 with the bevelled engagement surface 70b of the locking tab 70 overcomes the torsional force of the rotation biasing spring 64 and the force of the longitudinal biasing spring forces the locking pin 62 longitudinally forward towards the locking tab 70, thereby causing the rotation of the rotating locking pin 62, as it is moved forwardly towards the locking tab 70 by the movement of the article support 30. Hence, the locking tooth 63 is guided around the locking tab 70 through the rotation of the rotating locking pin 62. One skilled in the art will understand that the stopper 92 and abutment wall 93 of the pin engagement member 91 of the depression 68 are positioned and configured such that the abutment wall 93 does not engage the stopper 92 as the rotating locking pin 62 is rotated to move around the locking tab 70 (i.e. the rotating locking pin 62 is not rotated enough to have the stopper 92 being positioned to be engaged by the abutment wall 93 of the pin engagement member 91).

In FIG. 3D, the locking unit 61 is shown in a locked configuration occurring as the rack 10 reaches the transport configuration and the locking pin 62 is moved longitudinally along the X axis sufficiently to move the locking tooth 63 past the bevelled engagement surface 70b of the locking tab 70. In this configuration, the rotating locking pin 62 is moved back to the locking angular orientation (where the locking tooth 63 extends substantially downwardly from the rotating locking pin 62 in the embodiment shown) by the torsional force of the rotation biasing spring 64. In this configuration, the rack 10 is locked in the transport configuration by the engagement of the locking surface 63a of the locking tooth 63 of the locking pin 62 with the locking surface 70a of the locking tab 70 preventing the rearward longitudinal movement of the locking pin 62. Since a movement away from the transport configuration (towards the loading configuration) requires such a rearwards longitudinal movement of the locking pin 62, the rack 10 is therefore locked in the transport configuration.

In FIG. 3E, the locking unit 61 is shown in a locked and tightened configuration occurring as the handle 65 is pivoted to the tightened configuration by a user to further tighten the locking unit 61 in the locked configuration and minimize vibration between the components of the locking unit 61. In this configuration, the rotation of the handle 65 pulls the locking pin 62 longitudinally towards the handle 65, such that the locking surface 63a of the locking tooth 63 of the locking pin 62 is tightly engaged with the locking surface 70a of the locking tab 70. In this configuration, the spring-loaded block 69 is pressured engaged to the corresponding section of the base section 12 and the spring 69a is compressed to provide a vibration dampener. One skilled in the art will understand that, in an alternative embodiment (not shown), the spring-loaded block 69 could rather be provided on the base section 12 to engage a section of the mobile section 61a of the locking unit. As previously mentioned, in another alternative embodiment (not shown) a different compressible component allowing vibration dampening when compressed between the fixed portion 61b and mobile portion 61a of the locking unit 61 could also be provided. The configuration shown in FIG. 3E is used to maintain the rack 10 in an optimized locked configuration and is designed to be the configuration in which the locking unit 60 is positioned to operate the vehicle.

In FIG. 3F, the locking unit 61 is shown in an unlocked configuration. This configuration occurs when a user wishes to unlock the rack 10 (to subsequently move it away from the transport configuration and towards the loading configuration). In this configuration, the handle 65 is pivoted back to the release configuration by the user and the handle 65 is rotated to cause a rotation of the rotating locking pin 62. The handle 65 is rotated until the until the rotating locking pin 62 reaches the unlocked angular orientation and the abutment wall 93 of the pin engagement section 91a of the pin engagement member 91 abuts against the stopper 92.

As mentioned above, the stopper 92 is positioned to be engaged by the abutment wall 93 of the pin engagement member 91 when the rotating locking pin 62 reaches the unlocked angular orientation in which the locking tooth 63 of the rotating locking pin 62 is positioned to extend away from the locking tab 70, thereby allowing free longitudinal movement of the rotating locking pin 62 (without the locking surface 63a of the locking tooth 63 engaging the locking surface 70a of the locking tab 70).

As mentioned above, the pin engagement member 91 is biased towards the section of the peripheral surface of the rotating locking pin 62, and more particularly the side wall of the annular ring 83, as the rack 10 is still configured in the transport configuration. More specifically, in the embodiment shown and as can be better seen in FIGS. 3F and 4B, the rack engagement section 91b of the pin engagement member 91 is pressed against a fixed surface of the rack being the engagement surface 12a of the base section 12, thereby compressing the rack engagement section 91b towards the pin engagement section 91a and biasing the pin engagement section 91a towards the peripheral wall of the annular ring 83. Hence, during rotation of the rotating locking pin 62, the pin engagement section 91a moves along the side wall of the annular ring 83 and once the abutment wall 93 of the pin engagement section 91a of the pin engagement member 91 move beyond the angular position of the stopper 91, the shape of the pin engagement section 91a result in the abutment wall 93 of the pin engagement member 91 engaging the stopper 92 when the pin 62 is rotated in the opposite angular direction. The bias of the pin engagement section 91a towards the peripheral wall of the annular ring 83 maintains the abutment wall 93 of the pin engagement member 91 in engagement with the stopper 92. Hence, once the locking unit 61 is brought in the unlocked configuration shown in FIGS. 3F and 4B, it remains in this configuration until the the rack 10 is moved away from the transport configuration and the angular rotation restriction assembly 90 is deactivated (i.e. until the mobile portion 61a and fixed portion 61b of the locking unit 61 are moved away from one another). For example and without being limitative, this allows a user to move distinct locking units 61 to the unlocked configuration sequentially (without having to manually maintain a previously configured locking unit 61 in this configuration). This facilitates the unlocking of numerous locking unit 61, for example on large vehicle where the locking units 61 can be simultaneously out of reach for a single user.

Once the rack 10 is moved away from the transport configuration (i.e. once the mobile portion 61a and fixed portion 61b of the locking unit 61 are moved away from one another), the locking unit 61 is configured to automatically move back to the disengaged configuration shown in FIG. 3A, in which the rotating locking pin 62 is in the locking angular orientation (i.e. with the locking tooth 63 engageable with the locking tab 70). This is caused as the angular rotation restriction assembly 90 is deactivated as a result of the rack engagement section 91b of the pin engagement member 91 being disengaged from the fixed surface of the rack (i.e. from the engagement surface 12a of the base section 12) thereby resulting in the pin engagement member 91 not being biased towards the locking pin 62 anymore, such that the torsional force of the rotation biasing spring 64 rotates the locking pin 62 back to the locking angular orientation. In other words, when the pin engagement member 91 is disengaged from the fixed portion 61b of the locking unit 61 (i.e. the rack engagement section 91b of the pin engagement member 91 is disengaged from the engagement surface 12a of the base section 12, in the embodiment shown), the engagement between the abutment wall 93 of the pin engagement member 91 and the stopper 92 is broken by the torsional force of the rotation biasing spring 64 and the locking pin 62 is rotated back to the locking angular orientation by the rotation biasing spring 64.

The above-described locking mechanism 60 allows the rack 10 to be assily unlocked, while automatically being locked in place when it is brought in the transport configuration, thereby preventing the rack form inadvertently moving away from the transport configuration after being brought to this configuration, unless the locking mechanism 60 is manually unlocked.

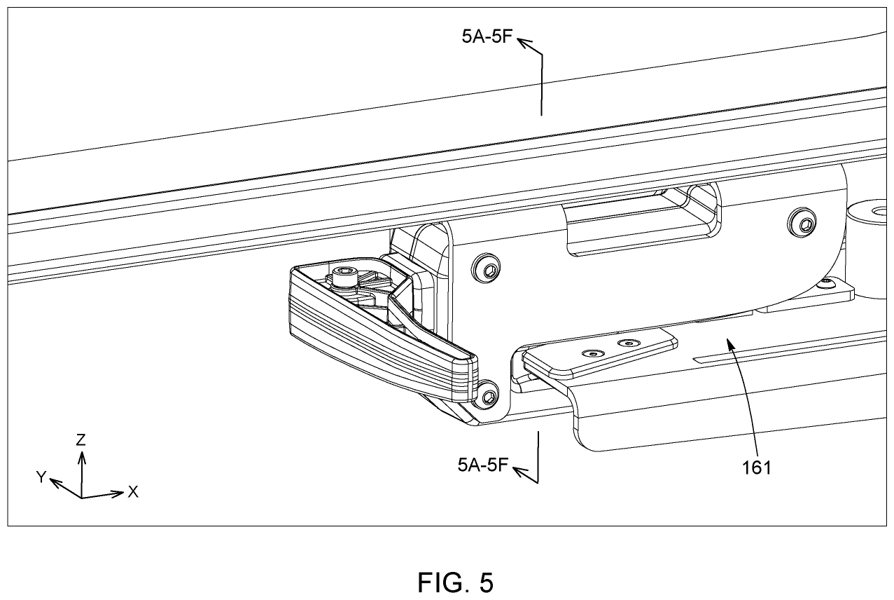

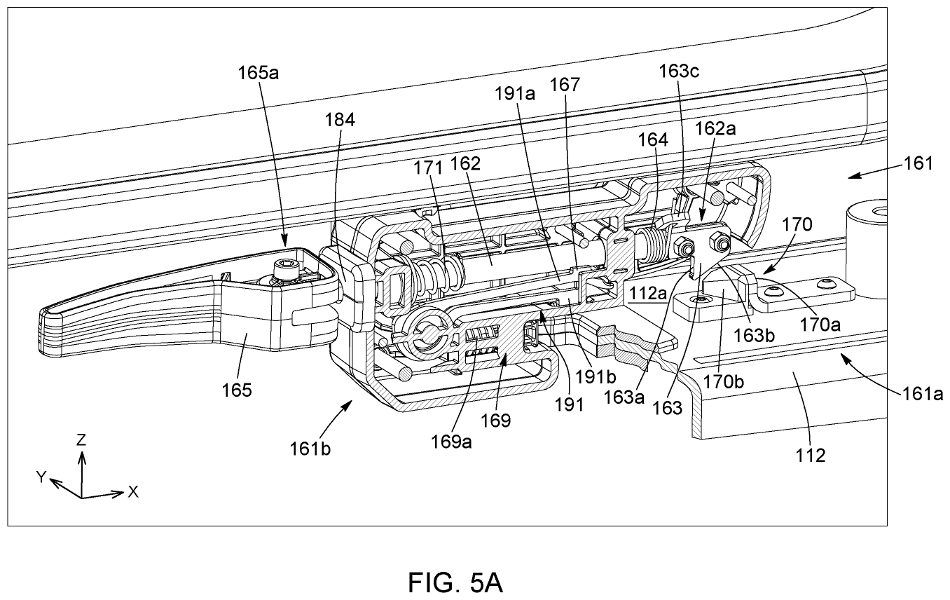

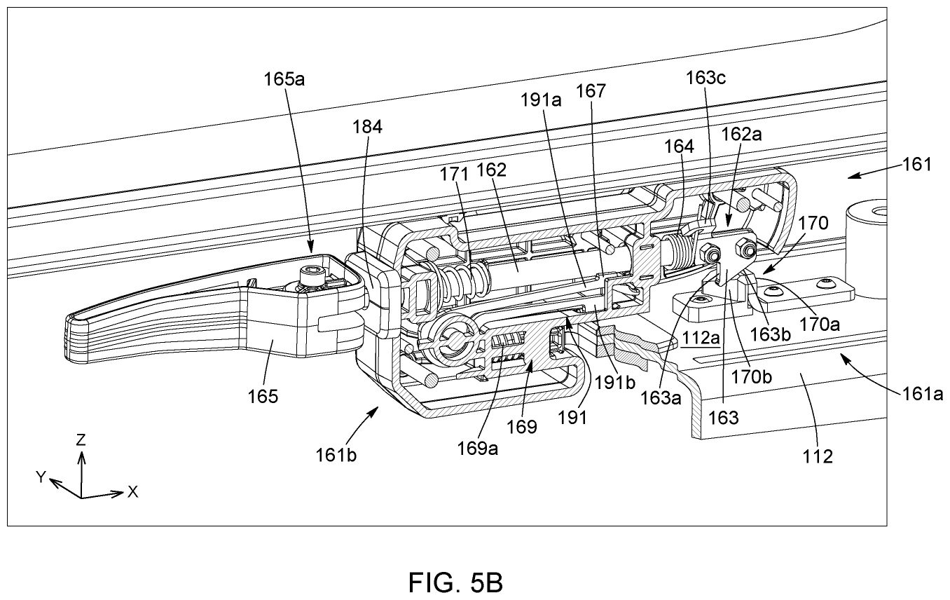

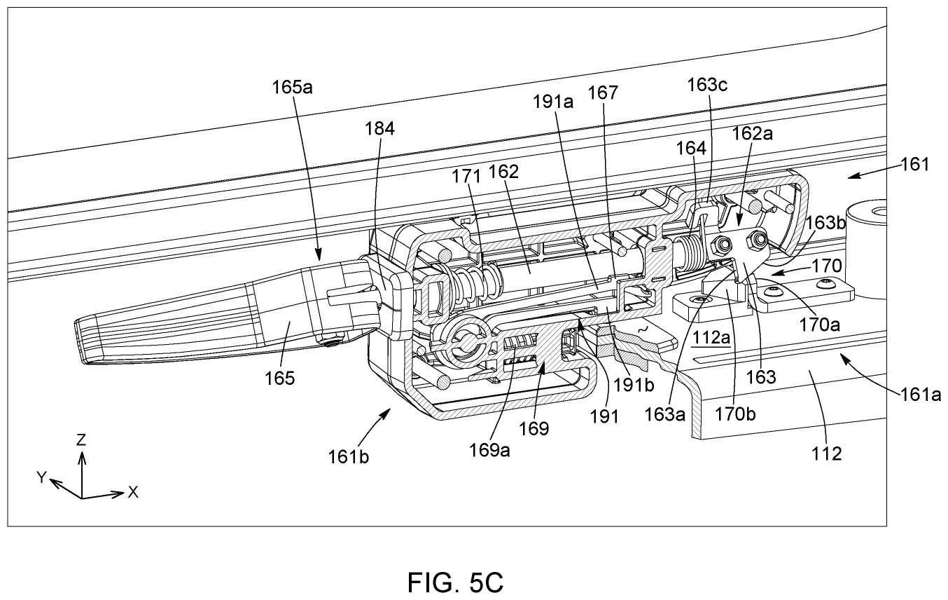

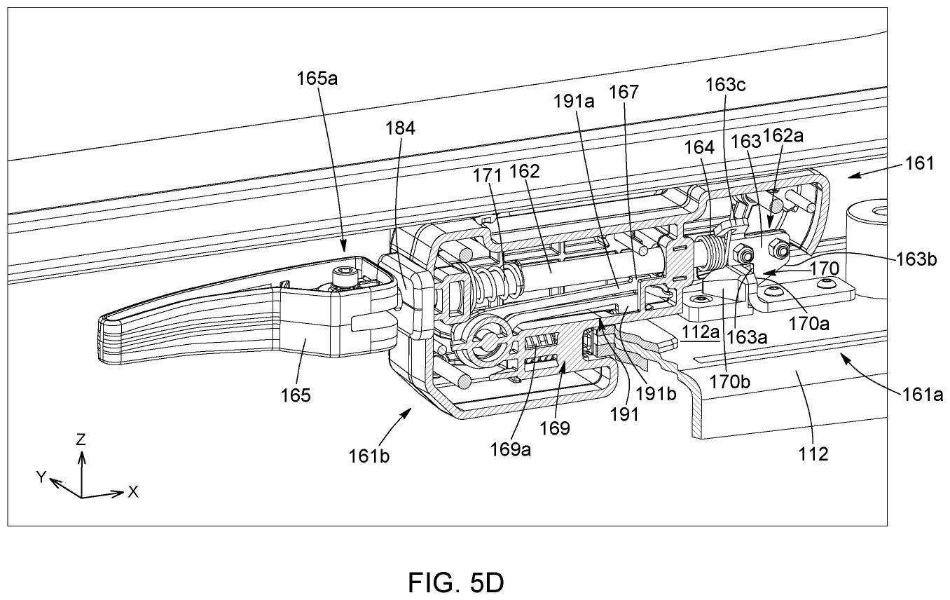

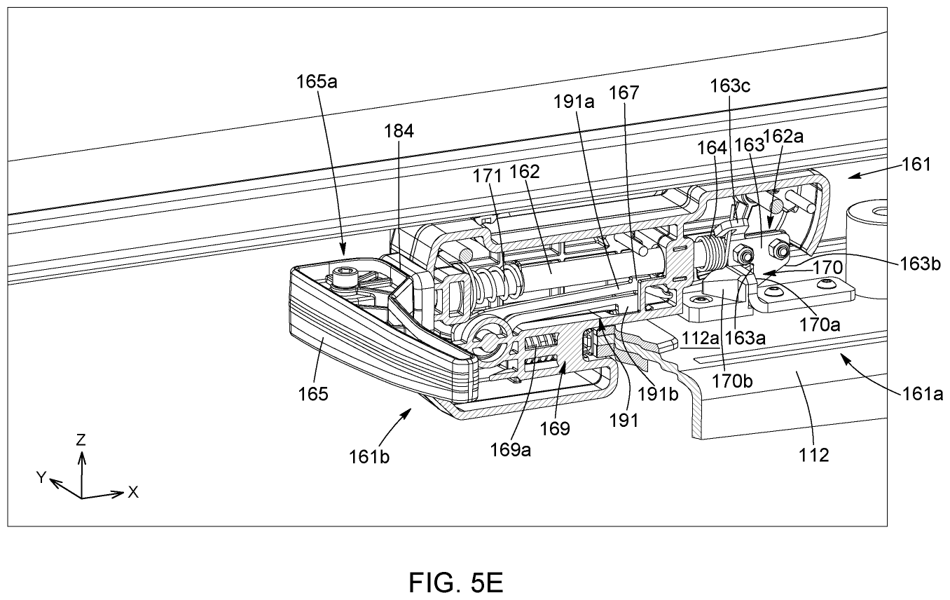

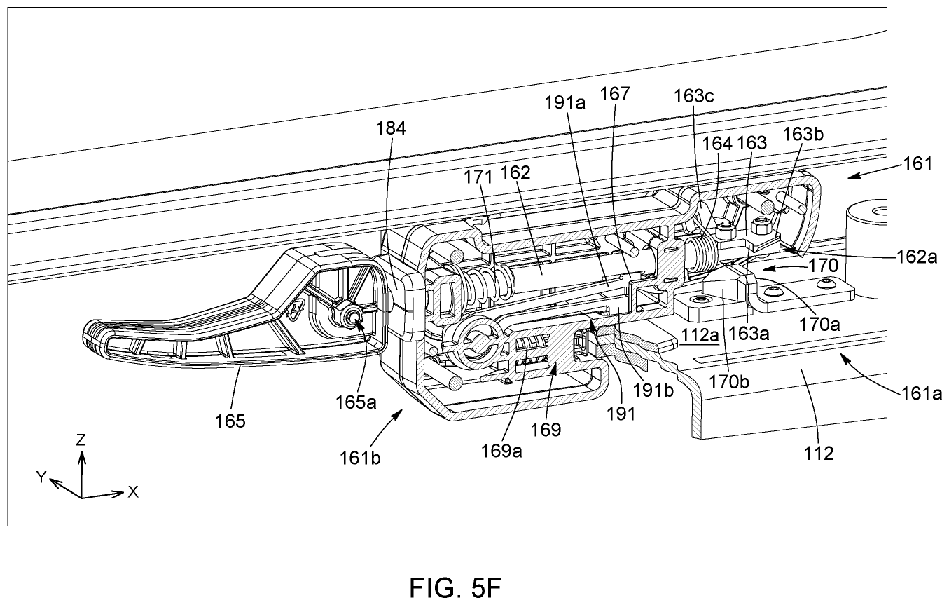

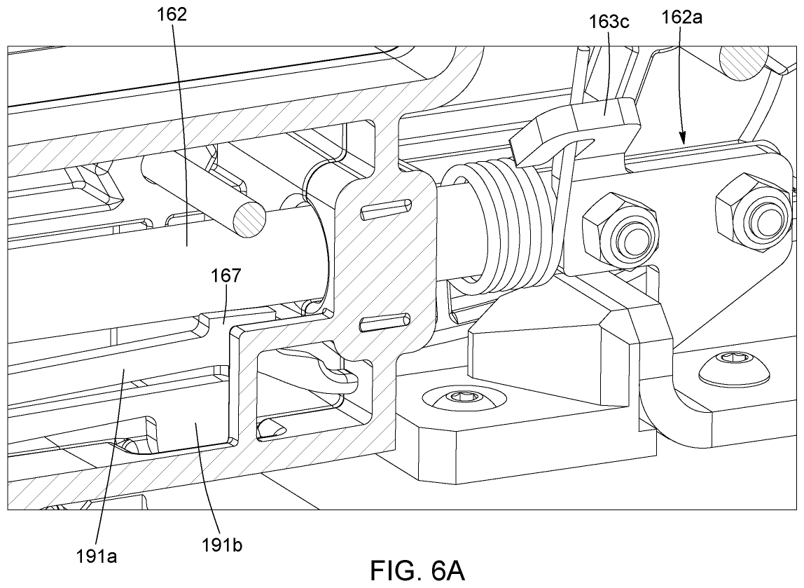

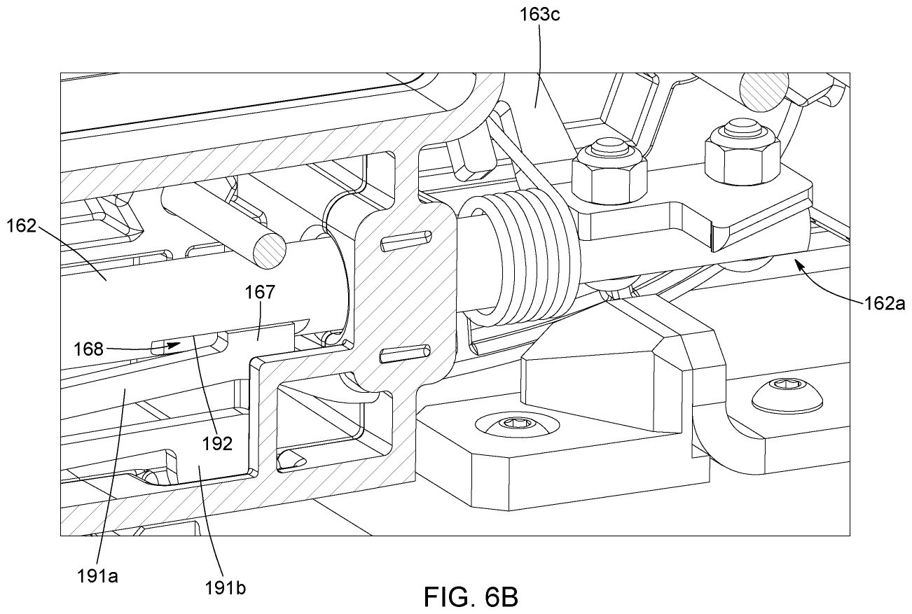

Now referring to FIG. 5 to 6B, there is shown an alternative embodiment of the locking unit mechanism 60, wherein the features are numbered with reference numerals in the 100 series which correspond to the reference numerals of the previous embodiment.

In this alternative embodiment, the locking unit 161 of the locking mechanism 60 still includes a mobile portion 161a and a fixed portion 161b engageable with one another and being positioned similarly to he above-described embodiment. Once again, in alternative embodiments (not shown), the mobile portion 61a and fixed portion 61b could be mounted to different components of the rack 10 than those of the embodiment shown.

The fixed portion 161b of the locking unit 161 still includes a receiving inlet 181 and the mobile portion 161a of the locking unit 161 still includes a projecting lip engageable under a section of the fixed portion 161b of the locking unit 161, when the mobile portion 161a of the locking unit 161 is engaged with the fixed portion 161b, thereby preventing the mobile portion 161a of the locking unit 161 to be moved upwardly away from the fixed portion 161b of the locking unit 161, while the mobile portion 161a of the locking unit 161 is engaged with the fixed portion 161b.

The locking tab 170 of the fixed portion 161b of the locking unit 161 is similar to the one described in the previous embodiment and includes a locking surface 170a extending substantially perpendicularly from the engagement surface 112a, and a bevelled abutment surface 170b extending forwardly of the locking surface 170a.

The mobile portion 161a again includes a rotating locking pin 162 extending substantially horizontally along a horizontal axis X and rotatable about the horizontal axis X and having a locking tooth 163 mounted thereon, at a distal end 162a of the locking pin 162 with a locking surface 163a and a bevelled abutment surface 163b to engage the engagement surface 170b of the locking tab 170 when the rack 10 is brought in the transport configuration and the mobile portion 161a and fixed portion 161b are engaged to one another).

The rotating locking pin 162 is again rotatively biased towards a locking angular orientation (as shown in FIGS. 5A, 5B, 5D and 5E, where the locking tooth 163 extends substantially downwardly from the rotating locking pin 162) by a rotation biasing member 164. Once again, in the embodiment shown, the rotation biasing member 164 is a rotation biasing spring but one skilled in the art would understand that a different rotation biasing member 164 could be used.

In the embodiment shown, the rotation biasing spring is positioned proximate to the locking tooth 163 and has a first end thereof engageable with a spring receiving section 163c thereof, which rotates along with the rotating locking pin 162, and a second end engageable with a fixed component of the mobile portion 161a, which does not rotate along with the rotating locking pin 162, such that rotation of the rotating locking pin 162 loads the spring to perform the rotation biasing function thereof towards the locking angular orientation.

The rotating locking pin 162 is again connected to a handle 165 at a proximal end thereof with the handle 165 being rotatable about the horizontal axis X and being rotatively fixedly mounted to the rotating locking pin 162, to rotate the locking pin 162 about the horizontal axis X upon rotation thereof. The handle 165 again includes a cam shaped section abutted against a handle abutment surface 184 and is pivotable relative to the rotating locking pin 162 about a handle pivot point 165ab between the release configuration (shown in FIGS. 5A to 5D) and a tightened configuration (shown in FIG. 5E).

Similarly to the above described embodiment, a longitudinal biasing spring 171 is provided to exert a force biasing the rotating locking pin 162 longitudinally away from the handle 165 and a spring-loaded block 169 presurable against a section of the base section 112 is provided in the mobile portion 161a of the locking unit 161. The spring-loaded block 169 includes a spring 169a compressible, when the handle 165 is moved to the tightened configuration.

Once again, an angular rotation restriction assembly 190 is activatable when the rotating locking pin 162 is rotated into the unlocked angular orientation (shown in FIGS. 5F and 6B) and the rack is configured in the transport configuration, to maintain the rotating locking pin 162 in the unlocked angular orientation until the angular rotation restriction assembly is deactivated. In the embodiment shown, the angular rotation restriction assembly is embodied by a combination of the pin engagement member 191 and the stopper defined by the depression 168 in the section of the peripheral surface of the rotating locking pin 162, as described below.

The pin engagement member 191 is again positioned and configured to be biased towards the section of the peripheral surface of the rotating locking pin 162 when the rack 10 is configured in the transport configuration and to be unbiased when the rack 10 is moved away from the transport configuration. In the embodiment shown, the pin engagement member 191 is a wishbone shaped member extending longitudinally in a direction of the rotating locking pin 162 and having a pin engagement section 191a and a rack engagement section 191b joined to one another at a connecting base. The wishbone shaped pin engagement member 191 is made of resilient material, with the pin engagement section 191a and rack engagement section 191b being spaced apart from one another. As will be described in more details below, the wishbone shaped pin engagement member 191 is positioned and configured for the pin engagement section 191a to engage a section of the peripheral surface of the rotating locking pin 162, when the rack 10 is configured in the transport configuration (see FIG. 6A). In the embodiment shown, the pin engagement section 191a of the wishbone shaped pin engagement member 191 also includes a projecting portion defining a blocking tab 167.

The rotating locking pin 62 has a depression 168 in a section of the peripheral surface thereof and defining a stopper 192 sized, shaped and positioned to allow at least a section of the blocking tab 167 of the pin engagement member 191 to be insertable therein, when the rotating locking pin 162 is rotated into the unlocked angular orientation in which the locking tooth 163 of the rotating locking pin 162 is positioned to extend away from the locking tab 170 (see FIG. 6B).

Operation of the locking unit 161 shown in FIGS. 5A to 6B, is similar to the above-described embodiment, except for the operation of the angular rotation restriction assembly 190 temporarily maintaining the locking unit in an unlocked configuration, when the rack is in the transport configuration.

In FIG. 5A, the locking unit 161 is again shown in a disengaged configuration (with the mobile portion 61a and fixed portion not being engaged to one another) and the rotating locking pin 62 in the locking angular orientation.

In FIG. 5B, the locking unit 161 is shown in the first engagement configuration occurring as the rack 10 is moved towards the transport configuration and the mobile portion 61a and fixed portion start engaging one another, with the abutment surface 163b of the locking tooth 163 of the rotating locking pin 162 initially abutting the engagement surface 170b of the locking tab 170, as the rack 10 is moved to be brought in the transport configuration.

In FIG. 5C the locking unit 61 is shown in the second engagement configuration occurring as the rack 10 is moved further towards the transport configuration, with the engagement of the bevelled abutment surface 163b of the locking tooth 163 with the bevelled engagement surface 170b of the locking tab 170 causing the rotation of the rotating locking pin 162, as it is moved forwardly towards the locking tab 170 by the movement of the article support 30. Once again, the rotating locking pin 162 is not rotated enough to engage the blocking tab 167 of the pin engagement section 191a of the pin engagement member 191 with the stopper 192).

In FIG. 5D, the locking unit 61 is shown in the locked configuration occurring as the rack 10 reaches the transport configuration and the locking pin 162 is moved longitudinally along the X axis sufficiently to move the locking tooth 163 past the bevelled engagement surface 170b of the locking tab 170, with the rotating locking pin 62 being moved back to the locking angular orientation (where the locking tooth 163 extends substantially downwardly from the rotating locking pin 162 in the embodiment shown) by the torsional force of the rotation biasing spring 164.

In FIG. 5E, the locking unit 161 is shown in the locked and tightened configuration occurring as the handle 165 is pivoted, with the locking surface 163a of the locking tooth 163 of the locking pin 162 being engaged and pressed against the locking surface 170a of the locking tab 170. In this configuration, the spring-loaded block 169 is pressured against the corresponding section of the base section 112 and the spring 169a is compressed to provide a vibration dampener.

In FIG. 5F, the locking unit 161 is shown in the unlocked configuration used to move the rack away from the transport configuration and towards the loading configuration. The handle 165 is pivoted back to the release configuration and the handle 165 is rotated to cause a rotation of the rotating locking pin 162 until the blocking tab 167 of the pin engagement member 191 is engaged into the depression 168 defined in the peripheral surface of the rotating locking pin 162. As mentioned above, the depression 168 is positioned to be engaged by the blocking tab 167 of the pin engagement member 191 when the rotating locking pin 162 is in the unlocked angular orientation in which the locking tooth 163 of the rotating locking pin 162 is positioned to extend away from the locking tab 170, thereby allowing free longitudinal movement of the rotating locking pin 162. As mentioned above, the pin engagement member 191 is again biased towards the section of the peripheral surface of the rotating locking pin 162 as the rack 10 is still configured in the transport configuration. More specifically, in the embodiment shown and as can be better seen in FIGS. 5F and 6B, the rack engagement section 191b of the wishbone shaped pin engagement member 191 is pressed against the engagement surface 112a of the base section 112, thereby compressing the rack engagement section 191b towards the pin engagement section 191a to bias the pin engagement section 191a towards the peripheral surface of the rotating locking pin 162. The bias of the pin engagement section 191a towards the peripheral surface of the rotating locking pin 162 causes the pin engagement member 191 to maintain the rotating locking pin 162 in the unlocked angular orientation once the blocking tab 167 is engaged with the stopper 192 defined by the depression 168 in the peripheral surface of the rotating locking pin 162. Hence, once the locking unit 161 is brought in the unlocked configuration shown in FIGS. 5F and 6B, it remains in this configuration until the rack 10 is moved away from the transport configuration (i.e. until the mobile portion 161a and fixed portion 161b of the locking unit 161 are moved away from one another).

Once the rack 10 is moved away from the transport configuration (i.e. once the mobile portion 161a and fixed portion 161b of the locking unit 161 are moved away from one another), the locking unit 161 is configured to automatically move back to the disengaged configuration shown in FIG. 5A, as a result of the rack engagement section 191b of the pin engagement member 191 being disengaged from the fixed surface of the rack (i.e. being disengaged from the engagement surface 112a of the base section 112 in the embodiment shown), thereby resulting in the pin engagement member 191 not being biased towards the locking pin 162 anymore, such that the torsional force of the rotation biasing spring 164 rotates the locking pin 162 back to the locking angular orientation. In other words, when the pin engagement member 191 is disengaged from the fixed portion 161b of the locking unit 161 (i.e. the rack engagement section 191b of the wishbone shaped pin engagement member 191 is disengaged from the corresponding section of the base section 112, in the embodiment shown), the blocking tab 167 of the pin engagement member 191 is disengaged from stopper 192 by the torsional force of the rotation biasing spring 164 and the locking pin 162 is rotated back to the locking angular orientation by the rotation biasing spring 164.

The above-described locking mechanism 160 therefore allows the rack 10 to automatically lock in place when it is brought in the transport configuration, thereby preventing the rack 10 form inadvertently moving when the vehicle is in use, for example. Furthermore, it allows each locking unit 60, 160 to be individually maintained in an unlocked position when the rack 10 is in the transport configuration (for example to allow a single user to position multiple locking units 60, 161 in the unlocked position, for subsequent movement to the loading configuration), and be automatically moved back to a locking configuration when moved away from the transport configuration, to allow the rack 10 to automatically be locked in the transport configuration by the locking mechanism 60, 160, the next time it is brought in the transport configuration.

Several alternative embodiments and examples have been described and illustrated herein. The embodiments of the invention described above are intended to be exemplary only. A person of ordinary skill in the art would appreciate the features of the individual embodiments, and the possible combinations and variations of the components. A person of ordinary skill in the art would further appreciate that any of the embodiments could be provided in any combination with the other embodiments disclosed herein. It is understood that the invention could be embodied in other specific forms without departing from the central characteristics thereof. The present examples and embodiments, therefore, are to be considered in all respects as illustrative and not restrictive, and the invention is not to be limited to the details given herein. Accordingly, while the specific embodiments have been illustrated and described, numerous modifications come to mind. The scope of the invention is therefore intended to be limited solely by the scope of the appended claims.

1. A locking mechanism for a rack mountable to a roof rack of a vehicle and movable to a transport configuration, the locking mechanism comprising:
a locking tab;
a rotating locking pin extending along a longitudinal axis and rotatable about the longitudinal axis, the rotating locking pin being longitudinally movable along the longitudinal axis as the rack is moved to the transport configuration or is moved away from the transport configuration;
a locking tooth positioned at a distal end of the rotating locking pin, with the rotating locking pin being rotatable between a locking angular orientation where the locking tooth is engageable with the locking tab as the locking pin is moved longitudinally along the longitudinal axis and an unlocked angular orientation where the locking tooth does not engage with the locking tab as the locking pin is moved longitudinally along the longitudinal axis;
a rotation biasing member rotatively biasing the rotating locking pin towards the locking angular orientation; and
an angular rotation restriction assembly activatable when the rotating locking pin is rotated into the unlocked angular orientation and the rack is configured in the transport configuration, the angular rotation restriction assembly being configured to maintain the rotating locking pin in the unlocked angular orientation until the angular rotation restriction assembly is deactivated.

2. The locking mechanism of claim 1, wherein the angular rotation restriction assembly is configured to be automatically deactivated when the rack is moved away from the transport configuration.

3. The locking mechanism of claim 2, wherein the angular rotation restriction assembly comprises:
a pin engagement member having a pin engagement section biased towards a section of the peripheral surface of the rotating locking pin when the rack is configured in the transport configuration and unbiased when the rack is moved away from the transport configuration; and
a stopper defined in the peripheral surface of the rotating locking pin, the stopper being sized and positioned to abut against at least a portion of the pin engagement section of the pin engagement member when the rotating locking pin is rotated into the unlocked angular orientation and thereby prevent rotation of the rotating locking towards the locking angular orientation while the pin engagement section is biased towards the section of the peripheral surface of the rotating locking pin.

4. The locking mechanism of claim 3, wherein the pin engagement member includes the pin engagement section and a rack engagement section, the pin engagement member being made of resilient material with the pin engagement section and rack engagement section being spaced apart from one another, and wherein the rack engagement section is abutted against a fixed surface of the rack when the rack is positioned in the transport configuration, to compress the rack engagement section towards the pin engagement section and bias the pin engagement section towards the peripheral surface of the rotating locking pin, and the rack engagement section is disengaged from the fixed surface of the rack when the rack is moved away from the transport configuration.

5. The locking mechanism of claim 1, wherein each one of the locking tooth and the locking tab includes an abutment surface and a locking surface, at least one of the abutment surface of the locking tooth and the locking tab being bevelled to cause a momentary rotation of the rotating locking pin as the locking tooth is moved past the locking tab by a forward longitudinal movement of the locking pin and the abutment surface of the locking tooth and the locking tab are abutted against one another, when the rack is moved to the transport configuration, with the rotation biasing member rotating the locking pin in the locking angular orientation once the locking tooth moves past the locking tab, thereby preventing a rearward longitudinal movement of the locking pin as the locking surface of the locking tooth is engageable to the locking surface of the locking tab.

6. The locking mechanism of claim 1, wherein the locking mechanism further comprises a handle mounted to the rotating locking pin at a proximal end thereof, the handle being rotationally fixed with the rotating locking pin such that rotation of the handle causes rotation of the rotating locking pin.

7. The locking mechanism of claim 6, wherein the handle includes a cam shaped section and is pivotable relative to the rotating locking pin about a handle pivot point between a release configuration and a tightened configuration, with the movement of the cam shaped section thereof against a handle abutment surface causing a longitudinal retraction of the locking pin along the longitudinal axis, towards the handle and away from the locking tab, when the handle is pivoted from the release configuration to the tightened configuration.

8. The locking mechanism of claim 1, wherein the locking mechanism further comprises a longitudinal biasing spring biasing the rotating locking pin towards the locking tab and away from the handle.

9. The locking mechanism of claim 1, wherein the locking mechanism further comprises a spring-loaded block including a spring longitudinally compressible along the X axis, the spring-loaded block being presurable against a fixed section of the rack when the handle is moved to the tightened configuration.

10. A rack mountable to a roof rack of a vehicle and movable to a transport configuration where the rack extends over the roof of the vehicle, the rack comprising:
at least one elongated base section mountable to the roof rack of the vehicle;
at least one pivoting link associated to a corresponding elongated base section of the at least one elongated base section and being rotatably mounted thereto;
an article support including at least one bracket associated to a corresponding one of the at least one pivoting link, each one of the at least one bracket having an upper end pivotally connected to the corresponding pivoting link;
a locking mechanism comprising:
a locking tab;
a rotating locking pin extending along a longitudinal axis and rotatable about the longitudinal axis, the rotating locking pin being longitudinally movable along the longitudinal axis as the rack is moved to the transport configuration or is moved away from the transport configuration,
a locking tooth positioned at a distal end of the rotating locking pin, with the rotating locking pin being rotatable between a locking angular orientation where the locking tooth is engageable with the locking tab as the locking pin is moved longitudinally along the longitudinal axis and an unlocked angular orientation where the locking tooth does not engage with the locking tab as the locking pin is moved longitudinally along the longitudinal axis;
a rotation biasing member rotatively biasing the rotating locking pin towards the locking angular orientation; and
an angular rotation restriction assembly activatable when the rotating locking pin is rotated into the unlocked angular orientation and the rack is configured in the transport configuration, the angular rotation restriction assembly being configured to maintain the rotating locking pin in the unlocked angular orientation until the angular rotation restriction assembly is deactivated.

11. The rack of claim 10, wherein the locking mechanism comprises at least one locking unit associated with a bracket of the article support and the corresponding elongated base section associated to the pivoting link associated with the bracket, the locking unit including a mobile portion mounted to the bracket and a fixed portion mounted to the elongated base section, the mobile portion being engageable with the fixed portion when the rack is configured in the transport configuration and wherein the locking tab is part of the fixed portion of the locking unit, while the rotation locking pin, locking tooth, rotation biasing member and angular rotation restriction assembly are part of the fixed portion of the locking unit.

12. The rack of claim 11, wherein the fixed portion of the locking unit includes a projecting lip engageable under a section of the fixed portion of the locking unit, when the mobile portion is engaged with the fixed portion.

13. The rack of claim 10, wherein the angular rotation restriction assembly of the locking mechanism is configured to be automatically deactivated when the rack is moved away from the transport configuration.

14. The rack of claim 13, wherein the angular rotation restriction assembly of the locking mechanism comprises:
a pin engagement member having a pin engagement section and a rack engagement section, with the pin engagement section being biased towards a section of the peripheral surface of the rotating locking pin when the rack is configured in the transport configuration and unbiased when the rack is moved away from the transport configuration; and
a stopper defined in the peripheral surface of the rotating locking pin, the stopper being sized and positioned to abut against at least a portion of the pin engagement section of the pin engagement member when the rotating locking pin is rotated into the unlocked angular orientation and thereby prevent rotation of the rotating locking towards the locking angular orientation while the pin engagement section is biased towards the section of the peripheral surface of the rotating locking pin.

15. The rack of claim 14, wherein the pin engagement member is made of resilient material with the pin engagement section and rack engagement section being spaced apart from one another, and wherein the rack engagement section is abutted against an engagement surface of the corresponding elongated base section when the rack is positioned in the transport configuration, to compress the rack engagement section towards the pin engagement section and bias the pin engagement section towards the peripheral surface of the rotating locking pin, and the rack engagement section is disengaged from the engagement surface of the corresponding elongated base section.

16. The rack of claim 10, wherein each one of the locking tooth and the locking tab assembly of the locking mechanism includes an abutment surface and a locking surface, at least one of the abutment surface of the locking tooth and the locking tab being bevelled to cause a momentary rotation of the rotating locking pin as the locking tooth is moved past the locking tab by a forward longitudinal movement of the locking pin and the abutment surface of the locking tooth and the locking tab are abutted against one another, when the rack is moved to the transport configuration, with the rotation biasing member rotating the locking pin in the locking angular orientation once the locking tooth moves past the locking tab, thereby preventing a rearward longitudinal movement of the locking pin as the locking surface of the locking tooth is engageable to the locking surface of the locking tab.

17. The rack of claim 10, wherein the locking mechanism further comprises a handle mounted to the rotating locking pin at a proximal end thereof, the handle being rotationally fixed with the rotating locking pin such that rotation of the handle causes rotation of the rotating locking pin.

18. The rack of claim 17, wherein the handle includes a cam shaped section and is pivotable relative to the rotating locking pin about a handle pivot point between a release configuration and a tightened configuration, with the movement of the cam shaped section thereof against a handle abutment surface causing a longitudinal retraction of the locking pin along the longitudinal axis, towards the handle and away from the locking tab, when the handle is pivoted from the release configuration to the tightened configuration.

19. The rack of claim 10, wherein the locking mechanism further comprises a longitudinal biasing spring biasing the rotating locking pin towards the locking tab and away from the handle.

20. The rack of claim 10, wherein the locking mechanism further comprises a spring-loaded block including a spring longitudinally compressible along the X axis, the spring-loaded block being presurable against a section of the elongated base section of the rack when the handle is moved to the tightened configuration.
